(19) United States
(12) Patent Application Publication
(10) Pub. No.: US 2026/0017717 A1
(43) Pub. Date: Jan. 15, 2026

(54) BIDDING METHOD FOR RENEWABLE ENERGY USING THE WASSERSTEIN DISTANCE

(71) Applicant: Gwangju Institute of Science and Technology, Gwangju (KR)

(72) Inventors: Jun Hyeok KIM, Gwangju (KR); Yun Su KIM, Gwangju (KR)

(21) Appl. No.: 19/265,553

(22) Filed: Jul. 10, 2025

(30) Foreign Application Priority Data
Jul. 11, 2024 (KR) 10-2024-0091737

(51) Int. Cl. G06Q 40/04; G06F 17/11; G06Q 10/04

(52) U.S. Cl. CPC G06Q 40/049; G06F 17/11; G06Q 10/04

(57) ABSTRACT

An embodiment relates to a method by which a virtual power plant (VPP) operator submits a bid for renewable energy in the electricity market. The bidding method for renewable energy according to an embodiment includes: generating a predicted power generation amount distribution for distributed energy resources; defining an ambiguity set for target power generation amount distributions of which a Wasserstein distance from the predicted power generation amount distribution is less than or equal to a reference value; setting an objective function that is in proportion to a revenue for the ambiguity set; and determining a power amount, which corresponds to any one target power generation amount distribution at which the objective function is maximum, as a bidding quantity.

### CROSS REFERENCE TO RELATED APPLICATION

The present application claims priority to Korean Patent Application No. 10-2024-0091737, filed on Jul. 11, 2024, the entire contents of which are incorporated herein for all purposes by this reference.

### BACKGROUND

### Technical Field

The present disclosure relates to a method by which a virtual power plant (VPP) operator submits a bid for renewable energy in the electricity market.

### Description of the Related Art

As distributed energy resources such as renewable generators, energy storage systems (ESSs), and demand response resources are increasingly integrated into the power grid, new markets that utilize distributed resources are being established in domestic and international electricity markets.

As one of them, the virtual power plant (VPP) business is emerging, which operates various types of distributed resources dispersed across different locations like a single power plant by integrating them and submits bids for generation capacity to the power exchange.

When participating in the day-ahead (DA) energy market, a VPP operator must establish a bidding strategy by taking into account the variability and prediction uncertainty of the power generation amount of renewable generators. If the actual power generation amount on the day differs significantly from a biding quantity submitted on the previous day, a penalty may be imposed on the VPP operator, and in some cases, the operator may even be disqualified from participating in the market in the future.

Accordingly, there is a need for a method of establishing a bidding strategy that is robust against risks by sufficiently considering the uncertainty of power generation by renewable energy sources.

### SUMMARY

An objective of the present disclosure is to enable virtual power plant operators to determine the power bidding quantity by considering the risks in an electricity market on their own.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a bidding method for renewable energy according to an embodiment of the present disclosure includes: generating a predicted power generation amount distribution for distributed energy resources; defining an ambiguity set for target power generation amount distributions of which a Wasserstein distance from the predicted power generation amount distribution is less than or equal to a reference value; setting an objective function that is in proportion to a revenue for the ambiguity set; and determining a power amount, which corresponds to any one target power generation amount distribution at which the objective function is maximum, as a bidding quantity.

According to the present disclosure, a virtual power plant operator can establish an optimal bidding strategy on its own by determining a risk that the operator can bear.

Further, according to the present disclosure, it is possible to prevent the imposition of an imbalance penalty on a virtual power plant operator.

Detailed effects of the present disclosure in addition to the above effects will be described with the following detailed description for accomplishing the present disclosure.

### BRIEF DESCRIPTION OF THE DRAWINGS

FIG. 1 is a diagram for describing a process in which a virtual power plant operator integrates distributed power sources and participates in the energy market;

FIG. 2 is a flowchart illustrating a renewable energy bidding method according to an embodiment of the present disclosure;

FIG. 3 is a diagram illustrating an example of a predicted power generation amount distribution;

FIG. 4 is a diagram for describing the Wasserstein distance between a predicted power generation amount distribution and a target power generation amount distribution; and

FIG. 5 is a diagram illustrating an hourly biding quantity and an hourly predicted market price determined in accordance with the operation of the present disclosure.

### DETAILED DESCRIPTION

The objectives, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure are described in detail with reference to the accompanying drawings. The same reference numerals are used to indicate the same or similar components in the drawings.

Although terms ‘first’, ‘second’, etc. are used to describe various components in the specification, it should be noted that these components are not limited by the terms. These terms are used to discriminate one component from another component and it is apparent that a first component may be a second component unless specifically stated otherwise.

Further, in the specification, when a certain configuration is disposed “over (or under)” or “on (beneath)” of a component in the following description, it may mean not only that the certain configuration is disposed on the top (or bottom) of the component, but that another configuration may be interposed between the component and the certain configuration disposed on (or beneath) the component.

Further, in the specification, when a certain component is “connected”, “coupled”, or “jointed” to another component, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In this application, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

The present disclosure relates to a method by which a virtual power plant (VPP) operator submits a bid for renewable energy in the electricity market. Before specifically describing the operation of the present disclosure, a process by which a virtual power plant operator participates in an electricity market will be first described.

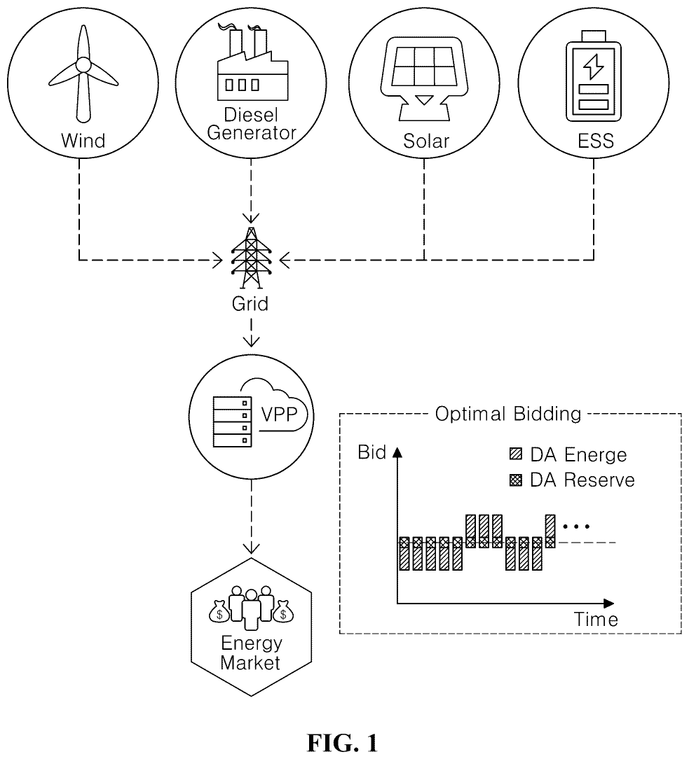

Referring to FIG. 1, a virtual power plant (VPP) operator may integrate distributed energy resources, such as renewable generators utilizing solar and wind energy, diesel generators using fossil fuels, and energy storage systems (ESS), operate them as a virtual power plant, and submit a bid for the power generation amount obtained from these distributed resources in an electricity market.

For example, a VPP operator may participate in a day-ahead (DA) electricity market by submit a bid for the power generation amount of distributed resources. The day-ahead electricity market may refer to a market in which the power bidding quantity for a trading day, which was determined on the basis of a power generation plan made one day prior to the trading day, is traded at the day-ahead market price. More specifically, it may refer to a market defined in the Market Operation Rules of the Korea Power Exchange.

In this bidding and trading scheme, if the deviation between an actual power generation amount on a trading day and a day-ahead bidding quantity exceeds a permissible error range (12% as of 2024), an imbalance penalty may be imposed on an VPP operator, and in severe cases, the operator may be disqualified from participating in the market in the future. Accordingly, a VPP operator must establish a bidding strategy that takes into account, particularly, the variability and prediction uncertainty of the power generation amount of renewable generators.

The present disclosure relates to a method of enabling a VPP operator to determine a bidding quantity robustly against the prediction uncertainty of renewable generators while avoiding imbalance penalties by reflecting the characteristics of an electricity market.

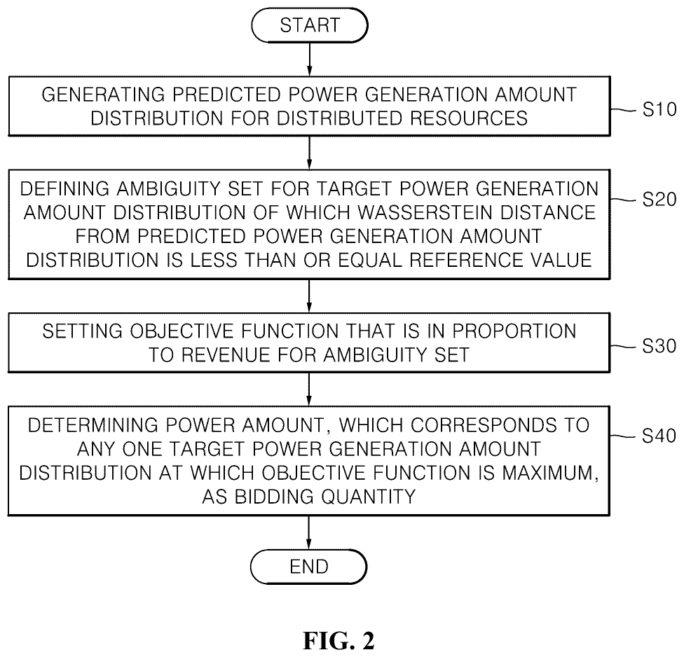

Hereinafter, a bidding method for renewable energy according to an embodiment of the present disclosure is described in detail with reference to FIGS. 2 to 5.

FIG. 2 is a flowchart illustrating a renewable energy bidding method according to an embodiment of the present disclosure.

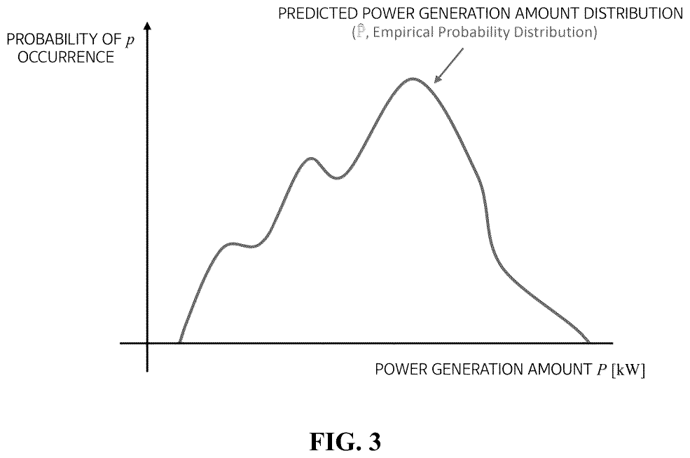

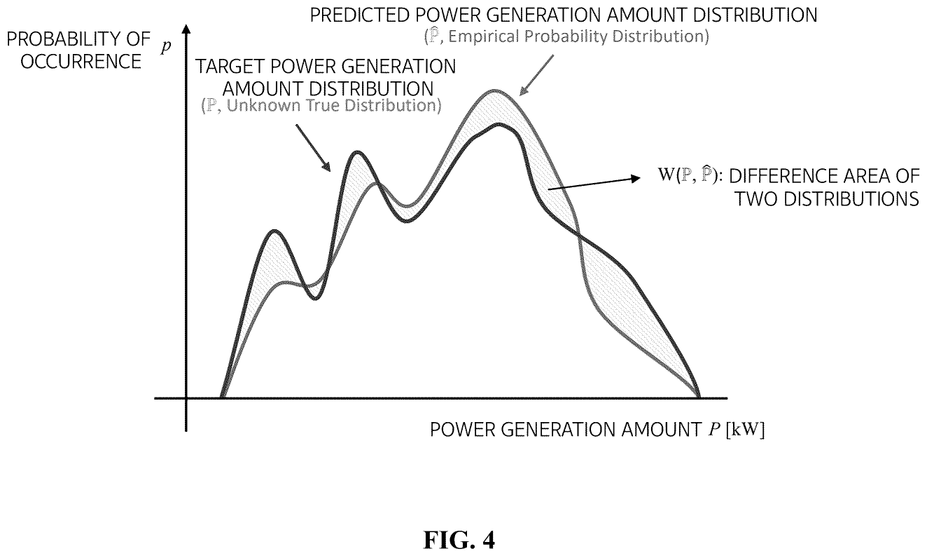

FIG. 3 is a diagram illustrating an example of a predicted power generation amount distribution and FIG. 4 is a diagram for describing the Wasserstein distance between a predicted power generation amount distribution and a target power generation amount distribution.

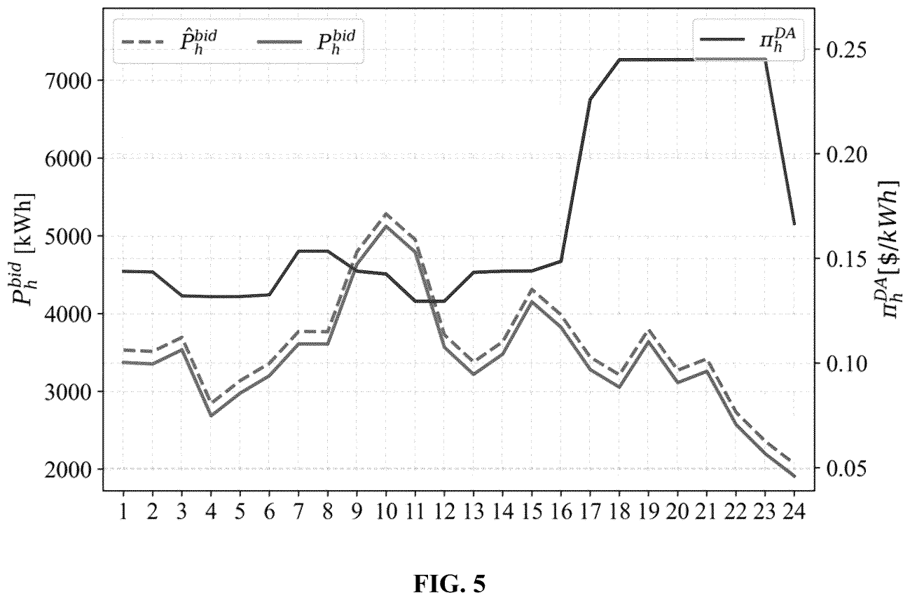

FIG. 5 is a diagram illustrating an hourly bidding quantity and an hourly predicted market price determined in accordance with the operation of the present disclosure.

Referring to FIG. 2, a bidding method for renewable energy according to an embodiment of the present disclosure may include: a step of generating a predicted power generation amount distribution for distributed energy resources; a step of defining an ambiguity set for a target power generation amount distribution of which the Wasserstein distance from the predicted power generation amount distribution is at or below a reference value; a step of setting an objective function that is in proportion to the revenue for the ambiguity set; and a step of determining the power amount corresponding to any one target power generation amount distribution, for which the objective function is maximized, as a bidding quantity.

However, the bidding method for renewable energy shown in FIG. 2 is merely one embodiment, the steps constituting the present disclosure are not limited to the embodiment illustrated in FIG. 2, and some steps may be added, changed, or omitted as necessary.

Meanwhile, the steps shown in FIG. 2 may be performed by a processor, and to this end, the processor may include at least one physical element of application specific integrated circuits (ASICs), digital signal processors (DSPs), digital signal processing devices (DSPDs), programmable logic devices (PLDs), field programmable gate arrays (FPGAs), micro-controllers, and a controller.

Hereafter, the steps shown in FIG. 2 are described in detail.

The processor may generate a predicted power generation amount distribution for distributed resources (S10). In other words, the processor may predict the power generation amount distribution for a trading day that has not yet arrived. Here, the power generation amount distribution may be defined as the probability of each power generation amount.

Referring to FIG. 3, in one embodiment, the processor may generate a predicted power generation amount distribution (empirical probability distribution) one the basis of the past power generation amount of distributed resources. Specifically, the processor may predict the power generation amount for a trading day on the basis of the historical power generation amount trend of each distributed resource constituting a virtual power plant, and may generate a predicted power generation amount distribution on the basis of the predicted power generation amount. In this case, various power generation amount prediction methodologies known in the art may be utilized to predict the power generation amount of each distributed resource.

Meanwhile, when there is no historical power generation amount trend for a distributed resource, for example, when a distributed resource is newly integrated into a virtual power plant, the processor may generate a predicted power generation amount distribution on the basis of simulation results for the distributed resource. Specifically, the processor may set a scenario on the basis of forecasts for renewable energy sources (solar, wind) for a trading day, and may generate a predicted power generation mount distribution in accordance with the scenario.

Subsequently, the processor may define an ambiguity set for a target power generation amount distribution of which the Wasserstein distance from the predicted power generation amount distribution is at or below a reference value (S20). In this case, the target power generation amount distribution may refer to the actual (unknown true) power generation amount distribution occurring on the trading day, and accordingly, the target power generation amount distribution may include uncertainty caused by renewable power generation.

Specifically, the processor can calculate the Wasserstein distance between a predicted power generation amount distribution and a target power generation amount distribution in accordance with the following [Equation 1].

$$W ( \hat{ℙ} , ℙ ) = {min}_{Π} {\int }_{{ℝ}^{\vert ℛ \vert} \times {ℝ}^{\vert ℛ \vert}} ‖ {ξ}_{1} - {ξ}_{2} ‖ Π ( d {ξ}_{1} , d {ξ}_{2} ) \qquad [ Equation 1 ]$$

(where W is the Wasserstein distance, Π is the joint distribution, [symbol] and [symbol] are a predicted power generation amount distribution and a target power generation amount distribution, respectively, and ξ₁ and ξ₂ are samples within the predicted power generation amount distribution and the target power generation amount distribution.)

Referring to FIG. 4, the processor can calculate a sum of differences between a predicted power generation amount distribution [symbol] for a trading day and a target power generation amount distribution [symbol] actually occurring on the trading day as a Wasserstein distance W. Accordingly, as shown in FIG. 4, an area difference between the predicted power generation amount distribution [symbol] and the target power generation amount distribution [symbol] can be calculated as the Wasserstein distance W.

Meanwhile, as described above, since the target power generation amount distribution includes uncertainty, the processor can define an ambiguity set by setting a condition for the Wasserstein distance. Specifically, the processor can define an ambiguity set in accordance with the following [Equation 2].

$$𝒟 := \{ ℙ ∈ 𝒫 ( Ω ) : W ( \hat{ℙ} , ℙ ) \leq θ \} \qquad [ Equation 2 ]$$

(where [symbol] is an ambiguity set, [symbol] and [symbol] are a predicted power generation amount distribution and a target power generation amount distribution, respectively, [symbol] (Ω) is a set of all distributions on the sample space, and θ is a reference value).

That is, the processor can define, as an ambiguity set, a target power generation amount distribution for which the Wasserstein distance between a predicted power generation amount distribution for a trading day and a target power generation amount distribution actually occurring on the trading day is within a reference value.

In this case, the reference value may be determined on the basis of a user-tolerable risk (hereinafter referred to as a user-defined risk). Specifically, the reference value may be set in proportion to the user-defined risk. For example, the greater the user-defined risk is, the larger the reference value θ may be set.

In an embodiment, the reference value may be determined on the basis of the number of predicted power generation amount distributions for a trading day and the user-defined risk, and specifically, it may be determined in accordance with the following [Equation 3].

$$θ = C \sqrt{\frac{1}{{N}_{s}} log ( \frac{1}{1 - ϵ} )} , C \approx {{inf}_{η > 0} ( \frac{1}{2 η} ( 1 + ln ( \frac{1}{{N}_{s}} {\sum }_{n}^{{N}_{s}} {e}^{η {‖ {ξ}_{n} - {μ}_{n} ‖}^{2}} ) ) )}^{1 / 2} \qquad [ Equation 3 ]$$

(where Nₛ is the number of predicted power generation amount distributions, ϵ is the user-defined risk (0≤ϵ≤1), ξₙ is a sample in each predicted power generation amount distribution, and μₙ is the average of samples in each predicted power generation amount distribution)

In this case, it is described in detail in “Distributionally robust chance-constrained approximate AC-OPF with Wasserstein metric,” IEEE Transactions on Power Systems, 33(5), 2018, pp. 4924-4936 (doi:10.1109/TPWRS.2018.2807623) that a constant C used in determining the reference value θ may be determined as shown in [Equation 3], and thus detailed description thereof is omitted herein.

Subsequently, the processor can set an objective function that is in proportion to the revenue for the ambiguity set defined in step S20. That is, the processor can set an objective function that is in proportion to the revenue for each of target power generation amount distributions constituting an ambiguity set, in other words, for each target power generation amount distribution of which the Wasserstein distance from a predicted power generation amount distribution is within the reference value.

In setting an objective function, if a distributed resource that consumes cost for power generation (for example, a diesel generator using fossil fuel) is included in a virtual power plant, the processor can set an objective function that is in proportion to net profit obtained by subtracting the cost required for operating the distributed resource from the revenue.

For example, when a virtual power plant includes a photovoltaic power plant, a wind power plant, a diesel generator, and an ESS as shown in FIG. 1, the processor can set an objective function for an ambiguity set in accordance with the following [Equation 4].

$${f}_{0} ( x , ξ ) = {max}_{x} \{ ( Rev ( x ) - Cost ( x ) ) \} \qquad [ Equation 4 ]$$

$$Rev ( x ) = {\sum }_{h}^{ℋ} {π}_{h}^{DA} {P}_{h}^{bid}$$

$${P}_{h}^{bid} = {\sum }_{i}^{ℐ} {P}_{i , h} + {\sum }_{v}^{𝒱} {P}_{v , h} + {\sum }_{w}^{𝒲} {P}_{w , h} + {\sum }_{s}^{𝒮} ( {P}_{s , h}^{dis} - {P}_{s , h}^{chg} )$$

$$Cost ( x ) = {\sum }_{i}^{ℐ} ( {c}_{2 i} {P}_{i , h}^{2} + {c}_{1 i} {P}_{i , h} + {c}_{0 i} {u}_{i , h} + {c}_{su , i} {su}_{i , h} + {c}_{sd , i} {sd}_{i , h} ) {FC}_{i}$$

(where Rev(x) is revenue, Cost(x) is the operating cost of a distributed resource, [symbol] is an expected value of each target power generation amount distribution [symbol] , h∈H is time, i∈I is the index of a diesel generator, s∈S is the index of an ESS, v∈V is the index of a photovoltaic power plant, w∈W is the index of a wind power plant, π^{DA} is a predicted market price, P^{bid} is a bidding quantity, P is a generated power amount, P^{dis} is a discharge amount of an ESS, P^{chg} is a charge amount of an ESS, c₂ᵢ, c₁ᵢ, and c₀ᵢ are the cost coefficients of diesel generators, respectively, c_{su,i} and c_{sd,i} are the start-up and shut-down cost coefficients of a diesel generator, respectively, u_{i,h} is a binary value indicating the operating state of a diesel generator, su_{i,h} and sd_{i,h} are binary values indicating the start-up and shut-down states of a generator, respectively, and FCᵢ is a fuel cost of the diesel generator)

Meanwhile, as will be described below, an objective function can be applied to an optimization algorithm (or tool) and the optimization algorithm can find a target power generation amount distribution that maximizes the objective function. In this case, the processor can set an objective function by fully considering the uncertainty inherent in renewable power plants.

Specifically, the processor can set an objective function that maximizes revenue while minimizing the difference between the Wasserstein distance and the reference value within the ambiguity set. In other words, the processor can set an objective function that maximizes revenue under the situation where uncertainty is maximum, and for this purpose, the objective function can be set in accordance with [Equation 5].

$${f}_{0} ( x , ξ ) = {max}_{x} {min}_{ℙ ∈ 𝒟} {𝔼}_{ℙ} \{ Rev ( x ) - Cost ( x ) ) \} \qquad [ Equation 5 ]$$

(where [symbol] is an expected value of each target power generation amount distribution, [symbol] is an ambiguity set, and the other parameters are the same as those described in [Equation 4])

Then, the processor can determine a power quantity corresponding to any one target power generation amount distribution for which the objective function set in step S30 is maximum, as a bidding quantity (S40).

The processor can identify any one target power generation amount distribution that maximizes an objective function by using an optimization algorithm known in the art. The optimization algorithm can specify a target power generation amount distribution that maximizes an objective function, and samples within the distribution. The samples may include information on hourly power quantities, and the processor can determine the hourly bidding quantities for a trading day on the basis of the hourly power quantities corresponding to the samples.

Meanwhile, the revenue from renewable power plants inherently includes uncertainty, so the objective function including it may not be in the form of a convex or concave function. When such an objective function is applied to an optimization algorithm, a local maximum point of the objective function can be found, but a global maximum point cannot be found. To overcome this limitation, the processor can convert an objective function into a convex form and can utilize various mathematical methodologies for this purpose.

Meanwhile, the processor can additionally set at least one constraint condition in addition to the objective function described above. For example, the constraint condition may define limitations on the minimum and maximum power generation amount of a diesel generator and a limitation on an hourly maximum power fluctuation. Further, the constraint condition may define limitations on the minimum and maximum storage amounts of an ESS, and on a limitation on the hourly maximum charging/discharging amount.

Further, the processor can additionally set constraint conditions based on a user-defined risk with respect to an ambiguity set. Specifically, the processor can restrict the probability that the total power generation amount error of a target power generation amount distribution does not exceed a certain percentage of a bidding quantity, on the basis of the user-defined risk, and for this purpose, can set constraint conditions in accordance with [Equation 6].

$${inf}_{ℙ ∈ 𝒟} ℙ [ - {1}^{T} {ξ}_{h} \leq ψ {P}_{h}^{bid} ] \geq 1 - ϵ , ∀ h \qquad [ Equation 6 ]$$

(where ξₕ is an hourly forecast error of a target power generation amount distribution, [symbol] is a target power generation amount distribution, [symbol] is an ambiguity set,

$${P}_{h}^{bid}$$

is an hourly bidding quantity, ϵ is a user-defined risk (0≤ϵ≤1), and ψ is a hyperparameter (0≤ψ≤1))

That is, the processor can set a constraint condition such that the probability that the total uncertainty (forecast error in power generation amount) of a target power generation amount distribution is smaller than $ ratio of a bidding quantity should be greater than or equal to 1−ϵ. Due to this constraint condition, the difference between a bidding quantity and an actual power generation amount may be within a ±ψ ratio over 1−ϵ probability.

Meanwhile, when setting a constraint condition, if a virtual power plant includes an ESS having reserve power, that is, stored power, the processor can limit the probability that the total power generation amount error of a target power generation amount distribution does not exceed the sum of a certain ratio of a bidding quantity and the reserve power, on the basis of a user-defined risk, and for this purpose, can set the constraint condition in accordance with [Equation 7].

$${inf}_{ℙ ∈ 𝒟} ℙ [ - {1}^{T} {ξ}_{h} \leq ψ {P}_{h}^{bid} + {R}_{h}^{bid} ] \geq 1 - ϵ , ∀ h \qquad [ Equation 7 ]$$

$$( {R}_{h}^{bid}$$

is hourly reserve power and the other parameters are the same as those described in [Equation 6])

That is, the processor can set a constraint condition such that the probability that the total uncertainty (power generation amount prediction error) of a target power generation amount distribution is less than the sum of the power corresponding to a ψ ratio of a bidding quantity and the hourly reserve power of an ESS is over 1−ϵ. Due to such a constraint condition, it may be conditioned to secure reserve power such that the difference between a bidding quantity and an actual power generation amount is within the ±ψ ratio over the 1−ϵ probability.

Meanwhile, in [Equations 6] and [Equation 7] described above, ψ, which determines the ratio of a bidding quantity, may be set as a power generation amount error rate at which an imbalance penalty is imposed on a virtual power plant operator. For example, when an imbalance penalty is imposed if the deviation between an actual power generation amount on a trading day and a day-ahead bidding quantity is 12%, ψ may be set to 0.12.

As a result, the constraint conditions described above allow a virtual power plant operator to set the probability of avoiding an imbalance penalty on its own through a user-defined risk, whereby it is possible to enable the virtual power plant operator participating in a power market to set a risk that the operator is willing to bear on its own.

The processor can determine a power amount, which corresponds to any one target power generation amount distribution that maximizes the objective function set in step S30 while satisfying the constraint conditions described above, as a bidding quantity.

Specifically, an optimization algorithm can identify a target power generation amount distribution, which maximizes an objective function among target power generation amount distributions that satisfy constraint conditions, and samples within the distribution. The samples may include information on hourly power quantities, and the processor can determine the hourly bidding quantities for a trading day on the basis of the hourly power quantities corresponding to the samples.

Meanwhile, since the constraint conditions described above also involve uncertainty due to a renewable power generation amount, the processor can convert the constraint conditions into a convex form, and for this purpose, can use various mathematical methodologies.

Referring to FIG. 5, it can be seen that the hourly first bidding quantity

$${P}_{h}^{bid} ,$$

which is determined in consideration of uncertainty in accordance with the present disclosure, is generally lower than a second bidding quantity

$${\hat{P}}_{h}^{bid} ,$$

which is predicted in accordance with a general optimization method without considering uncertainty.

On the surface, bidding in a power market using the second bidding quantity

$${\hat{P}}_{h}^{bid} ,$$

may appear to guarantee higher revenue, but, as described above, since the second bidding quantity

$${\hat{P}}_{h}^{bid} ,$$

does not take into account the uncertainty of a renewable power plant, so it may have a large difference from an actual power generation amount on a trading day and may result in an imbalance penalty.

In contrast, since the first bidding quantity

$${P}_{h}^{bid} ,$$

reflects the uncertainty of the renewable power plant with high reliability, the difference from the actual power generation amount on the trading day is minimal, and an imbalance penalty does not occur due to constraint conditions, it can be selected as a more efficient bidding strategy for a virtual power plant operator.

As described above, according to the present disclosure, a virtual power plant operator can establish an optimal bidding strategy on its own by determining a risk that the operator can bear. Further, according to the present disclosure, it is possible to prevent the imposition of an imbalance penalty on a virtual power plant operator.

Although the present disclosure was described above with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A bidding method for renewable energy using a Wasserstein distance, the bidding method comprising:
generating a predicted power generation amount distribution for distributed energy resources by means of a processor;
defining an ambiguity set for target power generation amount distributions of which a Wasserstein distance from the predicted power generation amount distribution is less than or equal to a reference value by means of the processor;
setting an objective function that is in proportion to a revenue for the ambiguity set by means of the processor; and
determining a power amount, which corresponds to any one target power generation amount distribution at which the objective function is maximum, as a bidding quantity by means of the processor.

2. The bidding method of claim 1, wherein the generating of a predicted power generation amount distribution includes generating the predicted power generation amount distribution on the basis of past power generation amounts of the distributed energy resources.

3. The bidding method of claim 1, wherein the generating of a predicted power generation amount distribution includes generating the predicted power generation amount distribution on the basis of simulation results for the distributed energy resources.

4. The bidding method of claim 1, wherein the Wasserstein distance is calculated in accordance with the following [Equation 1],
$$W ( \hat{ℙ} , ℙ ) = {min}_{\prod } {\int }_{{ℝ}^{\vert ℛ \vert} \times {ℝ}^{\vert ℛ \vert}} ‖ {ξ}_{1} - {ξ}_{2} ‖ \prod ( d {ξ}_{1} , d {ξ}_{2} ) \qquad [ Equation 1 ]$$
(where W is the Wasserstein distance, Π is a joint distribution, [symbol] and [symbol] are the predicted power generation mount distribution and the target power generation amount distribution, respectively, and ξ₁ and ξ₂ are samples within the predicted power generation amount distribution and the target power generation amount distribution, respectively).

5. The bidding method of claim 1, wherein the ambiguity set is defined in accordance with the following [Equation 2],
$$𝒟 := \{ ℙ ∈ 𝒫 ( Ω ) : W ( \hat{ℙ} , ℙ ) \leq θ \} \qquad [ Equation 2 ]$$
(where [symbol] is the ambiguity set, [symbol] and [symbol] are the predicted power generation amount distribution and the target power generation amount distribution, respectively, [symbol] (Ω) is a set of all distributions on a sample space, and θ is the reference value).

6. The bidding method of claim 1, wherein the setting of an objective function includes setting an objective function that is in proportion to a net profit obtained by subtracting a cost required to operate the distributed energy resources from the revenue.

7. The bidding method of claim 1, wherein the setting of an objective function includes setting an objective function that maximizes revenue while minimizing a difference between the Wasserstein distance and the reference value among the uncertainty set.

8. The bidding method of claim 1, wherein the setting of an objective function includes setting an objective function in accordance with the following [Equation 3],
$${f}_{0} ( x , ξ ) = {max}_{x} {min}_{ℙ ∈ 𝒟} {𝔼}_{ℙ} \{ Rev ( x ) - Cost ( x ) ) \} \qquad [ Equation 3 ]$$
(where f₀ is the objective function, [symbol] is the target power generation amount distribution, [symbol] is the ambiguity set, ξ is a sample in the target power generation amount distribution, and [symbol] is an expected value of the target power generation amount distribution).

9. The bidding method of claim 1, wherein the determining of a bidding quantity includes:
identifying any one target power generation amount distribution that maximizes the objective function, by using an optimization algorithm; and
determining hourly power amounts corresponding to the target power generation amount distribution as hourly bidding quantities.

10. The bidding method of claim 9, wherein the determining of a bidding quantity includes converting the objective function into a convex form and applying the objective function to an optimization algorithm.

11. The bidding method of claim 1, further comprising setting a constraint condition on the basis of a user-defined risk for the ambiguity set,
wherein the determining of a bidding quantity includes determining a power amount, which corresponds to any one target power generation amount distribution at which the objective function is maximum, while satisfying the constraint condition, as a bidding quantity.

12. The bidding method of claim 11, further comprising setting a constraint condition for the ambiguity set in accordance with the following [Equation 4],
$${inf}_{ℙ ∈ 𝒟} ℙ [ - {1}^{T} {ξ}_{h} \leq ψ {P}_{h}^{bid} ] \geq 1 - ϵ , ∀ h \qquad [ Equation 4 ]$$
(where ξₕ is an hourly forecast error of the target power generation amount distribution, [symbol] is the target power generation amount distribution, [symbol] is the ambiguity set,
$${P}_{h}^{bid}$$
bidding quantity, ϵ is a user-defined risk, and ψ is a hyperparameter).

13. The bidding method of claim 11, further comprising setting a constraint condition for the ambiguity set in accordance with the following [Equation 5],
$${inf}_{ℙ ∈ 𝒟} ℙ [ - {1}^{T} {ξ}_{h} \leq ψ {P}_{h}^{bid} + {R}_{h}^{bid} ] \geq 1 - ϵ , ∀ h \qquad [ Equation 5 ]$$
(where ξₕ is an hourly forecast error of the target power generation amount distribution, [symbol] is the target power generation amount distribution, [symbol] is the ambiguity set,
$${P}_{h}^{bid}$$
is an hourly bidding quantity,
$${R}_{h}^{bid}$$
hourly reserve power of the distributed resources, ϵ is a user-defined risk, and ψ is a hyperparameter).

14. The bidding method of claim 12, wherein the ψ is set as a power generation amount error rate at which an imbalance penalty is imposed.

15. The bidding method of claim 11, wherein the determining of a bidding quantity includes converting the constraint condition into a convex form and applying the constraint condition to an optimization algorithm.

16. The bidding method of claim 13, wherein the ψ is set as a power generation amount error rate at which an imbalance penalty is imposed.
